(19) United States
(12) Patent Application Publication
(10) Pub. No.: US 2005/0010317 A1
(43) Pub. Date: Jan. 13, 2005

(54) Method and apparatus for automated bi-directional integration of peripheral data sources for a production tool

(76) Inventors: Ron Hadar, Cupertino, CA (US); John Alexander Smith, Andover, MA (US); Gerhard Rupp, Kallmuenz (DE); Bernhard Schimunek, Anhausen (DE); Mark Attwood, Morgan Hill, CA (US); Lior Landesmann, Cupertino, CA (US); Brent Elliott, Cupertino, CA (US); Tim Robinson, Nantwich (GB); Uzi Lev-Ami, Mountain View, CA (US)

Correspondence Address: HAYNES BEFFEL & WOLFELD LLP, P O BOX 366, HALF MOON BAY, CA, 94019, US

(21) Appl. No.: 10/617,138

(22) Filed: Jul. 11, 2003

(51) Int. Cl. G06F 19/00

(52) U.S. Cl. 700/108; 700/121

(57) ABSTRACT

A method and apparatus for automated bidirectional integration of peripheral data sources for a production tool couples the system components together in a web-based arrangement. The process tools and the peripheral data sources are configured as websites to provide information to the system. Certain components of the system are also configured as browsers to obtain available information and use this information to make decisions and perform actions.

### BACKGROUND OF THE INVENTION

In modem manufacturing processes, it is generally desirable to provide as much control and automation as possible. Reduction in the number of human operators reduces the costs of manufacture, increases productivity, improves product yield, and allows for more precise processing, among other benefits. This is applicable to a number of different processes, including semiconductor manufacturing processes, for example.

Semiconductor processing systems are complicated and may require information from other subsystems in order to function effectively. Certain subsystems, such as in situ metrology units, including gas detectors, need to know when a manufacturing process is starting, when it is ending, when there is a switching from one recipe to another recipe, etc. This is because the gas being detected, and the level of gas, may be completely different for different recipes or based on other factors. While certain sensors merely provide for detection of a process parameter and producing sensoric data to reflect the detected process parameter, other sensors may be described as “intelligent” sensors that produce specific information that is context-dependent. Hence, an intelligent sensor may be monitoring for a specific gas that depends upon the specific recipe currently being used in the manufacturing process.

The use of intelligent sensors is known. Ad hoc methods have been employed to obtain data from these intelligent sensors. Each time an intelligent sensor is connected and set up, the intelligent sensor is adapted to the specific situation in which the intelligent sensor is to operate. Hence, a new recipe, or new version of a process, requires the sensor setup to be changed. Industries, such as the semiconductor industry, have tried to assemble systems that allow the intelligent sensors and other components of the manufacturing process to work together. This has proven to be difficult in practice, however, as being too complex and requiring too high a degree of cooperation between the various elements.

Certain intelligent sensors can be configured to perform certain actions, such as initiating calibration of the intelligent sensor. However, if these actions take place during certain time periods, unintended adverse consequences may result. For example, in a semiconductor processing chamber, if an intelligent sensor starts calibrating itself while a wafer is being processed in the chamber, the wafer may become damaged and lost. Skilled personnel are required to prevent any wafer loss by employing manual inputs to control the processing. With the ever increasing complexity of wafer production, the number of skilled operators that are required exceeds the number of skilled personnel that are available.

There is a need for a system that permits increased automation of the manufacturing process and improves the manufacturing process by enabling improvements in data flow between sensors and the rest of the system.

### SUMMARY OF THE INVENTION

This and other needs are met by embodiments of the present invention which provide a system for controlling a process comprising a process tool and a process controller that controls the process tool. At least one sensor is provided that senses a process parameter. A data transmission network couples the process controller and the at least one first sensor. The process controller and the at least one sensor are configured as web servers to deliver data over the data transmission network.

Another aspect of the present invention provides a system comprising a production tool and at least one peripheral data source at the production tool, and a network to which the production tool and at least one peripheral data source are coupled. The production tool and the at least one peripheral data source are configured for providing bi-directional flow of data over the network.

In a still further aspect of the invention, a method of controlling a manufacturing process is provided comprising the steps of sensing process parameter data at a process tool using a first sensor and obtaining logistical tool data at the first sensor. An action is performed at the first sensor based on the process parameter data and the logistical tool data.

### BRIEF DESCRIPTION OF THE DRAWINGS

FIG. 1 is a block diagram of an exemplary system constructed in accordance with embodiments of the present invention.

FIG. 2 schematically depicts the hierarchical control provided by embodiments of the present invention.

FIG. 3 depicts an exemplary embodiment of a method in accordance with embodiments of the present invention.

FIG. 4 is a block diagram depicting a fabrication-wide embodiment of the present invention.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

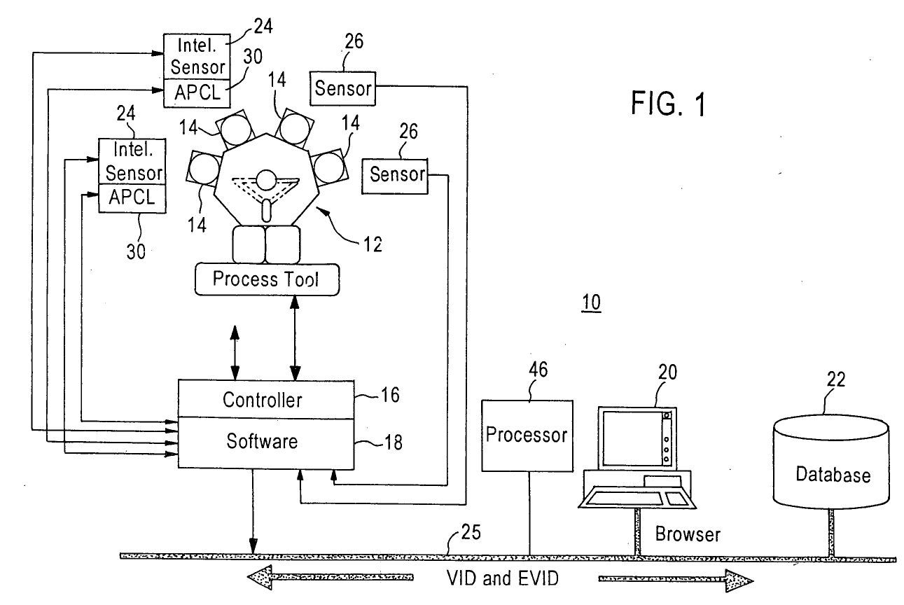

FIG. 1 depicts in block diagram form an exemplary system constructed in accordance with an embodiment of the present invention. As described herein, the exemplary system is a semiconductor manufacturing system for manufacturing semiconductor products. However, the present invention is not limited to such a system type, but can be applied to other manufacturing systems and processes. For illustrative purposes, however, the description of the exemplary embodiment of the invention provided below will be limited to a semiconductor manufacturing system.

The system 10 includes a process tool 12 having one or more process chambers 14. The invention is applicable to process tools of various types, such as deposition chambers, etchers, etc.

A process tool controller 16 is coupled to the process tool 12 and has access to parameters not available to any sensor. For example, the process tool controller 16 will receive an identification of the wafer being processed. The process tool controller 16 interacts with software 18 (depicted as a separate block for illustrative purposes), which accessed this information from the process tool controller 16. Further, the process tool controller 16 has the capability of stopping the operation of the process tool 12 in order to prevent damage.

A browser 20 and a database 22 are coupled to a data transmission network 25. An exemplary type of data transmission network 25 is an Ethernet network known to those of ordinary skill in the art. Other types of data transmission networks, such as wireless networks, may be employed without departing from the present invention. The browser 20 may comprise a conventional computer configured to perform browsing functions, processing data and displaying results to a user. The processing of data may also be performed by a separate processor 46, which can be a fab-level controller, in certain embodiments. The browser 20 may just be used for display purposes, in certain embodiments.

A number of sensors 24 and 26 are provided in or around the process tool 12. Sensors 24, 26 provide information related to the process being performed. For purposes of this embodiment, there are considered to be two different sensor types. The first of these (sensor 26) is a “direct parameter input sensor”, or non-intelligent sensor. Such sensors generate single value outputs correlated to one parameter of the process. Such an example of these sensors includes a particle counter sensor, which determines how many particles of a certain size are in the chamber at a specific time for a specific wafer. Other examples include sensors detecting film thickness, resistivity, wafer bar code reader, pressure reading, flow reading, wafer temperature, etc.

The other type of sensor is sensor 24, which is termed an “indirect parameter input sensor”, or intelligent sensor. This type of sensor 24 generates indirect parameter inputs that are found through instrumentation that interprets intelligently what the sensors experience. The interpretation is performed through mathematical, statistical, empirical, calculated and related methods. The parameters indicate quality and quantity indices. Such sensors 24 are available commercially. For example, sensor 24 may be a residual gas analysis (RGA) type of sensor, and provide both process and calculated indices. For example, the RGA sensor can provide value of the mass of the oxygen content in the chamber, and also provide a calculated index such as a photoresist index. In addition, the sensor 24 may have implication fields such as for trouble shooting the condition of a chamber in a pump down high vacuum state, and one for process monitoring in the low, medium or higher pressure state. Other types of intelligent sensors include a VI probe that delivers the data necessary to perform plasma diagnostics. Process related parameters are found, such as the value of the RF forward into the chamber, as well as calculated indices by the VI probe application, such as collision rate index. Still other types of intelligent sensors include pinpoint detectors, optical omission sensors, etc.

Hence, the intelligent sensors 24 do more than just transduce process parameters. A level of intelligence is provided that interprets and calculates the sensed parameter to provide data to process tool controller 16.

In conventional systems, sensors provide information to the process tool controller or other system that collects data. Intelligent sensors can be set up to provide some level of automation, but correlation of the process parameter data and the logistical tool data is difficult due to the complexity of communication protocols and the individual nature of each process and recipe. For example, once an intelligent sensor is configured to sense a certain condition and make a decision in accordance with a specific recipe process, a change in the recipe may require reconfiguration of the sensor in order to properly evaluate the sensed parameter as it relates to the process.

Rather than provide individual protocols in communication systems that are specific for each component of the system 10, the present invention configures the system 10 with web-based communication between the components. Each of the components that is coupled to the data transmission network 25 may be configured as a web site at which data is available. Many of the components also have a browsing capability to allow the component to search the system 10 for information (data). Thus, although not depicted in FIG. 1, each of the components has an embedded computer (not shown) that allows the component to be configured at least as a web site, and in certain instances, also has a browser. The components include, but are not limited to, the process tool 12, the process tool controller 16, the browser 20, the database 22, and the sensors 24, 26.

The components in system 10 may provide their data in the form of XML documents that are available to any of the other components of the system 10 that have a browsing capability. A conventional web-based browsing system and web site communication system and methodology may be employed to form the communications within the system 10.

The database 22 may be loaded with specific information regarding the configuration of the system 10, such as the specific process tool 12, and the specific sensors 24, 26 that are being employed. The database 22 may also contain information regarding a specific process or recipe that will currently be followed. The process tool controller 16 and the intelligent sensors 24 are able to use their browsing functionality to obtain this information. Once armed with the tool configuration and recipe information, the process tool controller 16 and the intelligent sensors 24 are able to carry out the indicated process.

During wafer processing, sensors 24 and 26 serve as web sites providing data over the data transmission network 5. Sensors 24, 26 and the process tool 16 provide this data through the software 18 to the network 24. Browser 20 is able to correlate wafer information with the data that is being provided by the sensors 24, 26. Correlation allows for greater control and information regarding the process can lead to process improvements.

As stated earlier, the data from the sensors 24, 26 may be considered to be different. The sensors 26 provides sensoric data that has not been interpreted. This data is made available to the system 10 on the websites formed by the sensors 26. By contrast, sensors 24 are intelligent sensors which can interpret and calculate sensoric data. This interpretation and calculation is based, in part, upon the information obtained through the browsing function of the sensors 24. For example, depending upon the recipe, a sensor 24 may be configured to determine an excess oxygen condition. The level of oxygen that defines an excess condition may change depending upon the recipe. The browsing by the sensor 24 provides the information that allows the sensor 24 to be configured to calculate the data appropriately. The information may be obtained from the database 22, for example.

The system 10, as depicted in FIG. 1, includes automatic pressure control loop elements 30, associated with the sensors 24. Such elements 30, like the sensors 24, 26, also provide process information to the system 10. The system 10 provides advanced process control that causes certain actions to be performed and control of the manufacturing process as a function of data obtained during the manufacturing process. For example, a sensor 24 may be able to calibrate its own system. However, if this happens while the wafer is being processed in the chamber of the process tool 12, a wafer will be damaged or lost. Sensor 24, however, is provided with enough information through the web-based system of the invention to enable the calibration to occur automatically. This information can include data that the chamber of the process tool 12 would not be processing during the next three minute time interval, for example. During such time interval, the sensor 24 may be calibrated.

The data from the sensors 24, 26 and the process tool 12 are made available in the form of variable IDs (VIDs) and extended VIDs (EVIDs). The VID and EVID data relate to the tool state, process parameters, etc. The connection through the software 18 allows the SVIDs and ESVIDs to be displayed on the browser 20 as a function of time or wafer/slot identification.

An advanced process control can be performed by the process tool controller 16 based on the information obtained by browsing. A feed forward control, dependent on the sensor information, can fine tune the manufacturing process and reduce the need for human operators.

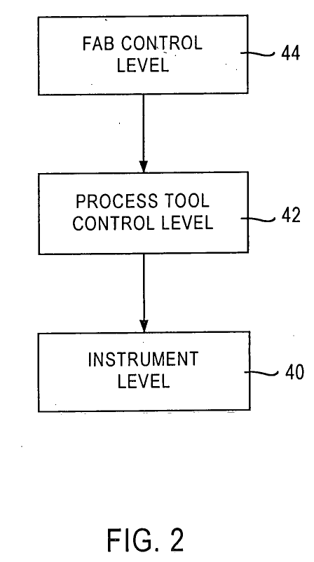

FIG. 2 is a simplified block diagram which shows the hierarchical control provided by embodiments of the present invention. The invention provides control of the instruments, such as the intelligent sensors 24, provided at the process tool 12. For example, intelligent sensor 24 is provided with the connectivity and capability to obtain information, generalize the information and provide reports to the next higher level of control. The instrument control level is indicated by reference numeral 40.

The next higher level in the hierarchy is a process tool control level 42 that concentrates all the knowledge about the process tool 12 and the sensors 24, 26 and reconciles it with a fab-wide server. This level 42 performs the data collection from the tool and tool instruments, and shares and transfers data between the instruments, the tool, the fab and other applications, such as machine stop, data storage, fault detection, etc.

The third level of hierarchy is the fab control level 44 that represents common modules for data collection, storage and database management, reporting and visualization. Other applications include, but are not limited to, e-diagnostics, fault detection and classification, advanced process control, etc.

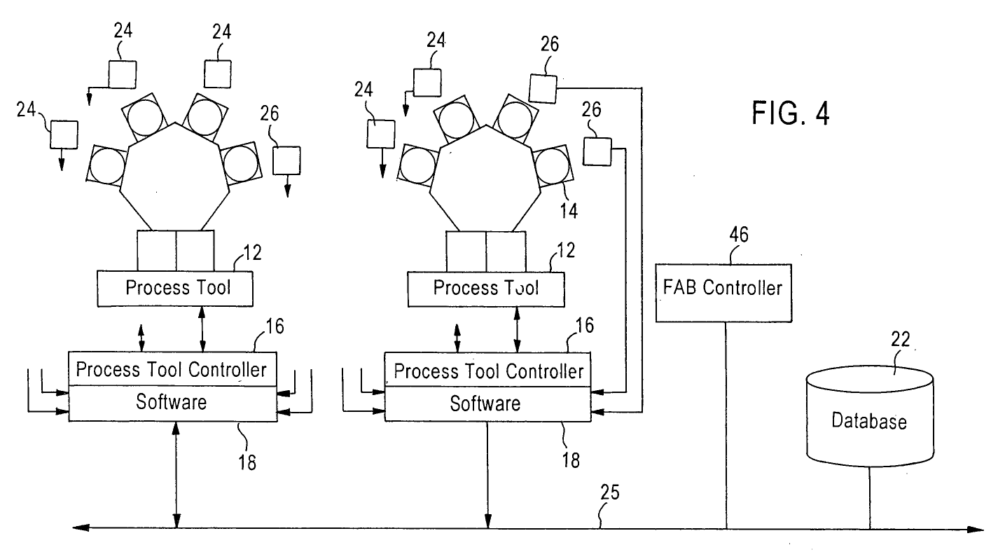

FIG. 4 depicts in block diagram form a number of process tools connected to the data transmission network 25 in an enterprise wide fabrication system. These process tools 12 are under the control of a fab controller 46.

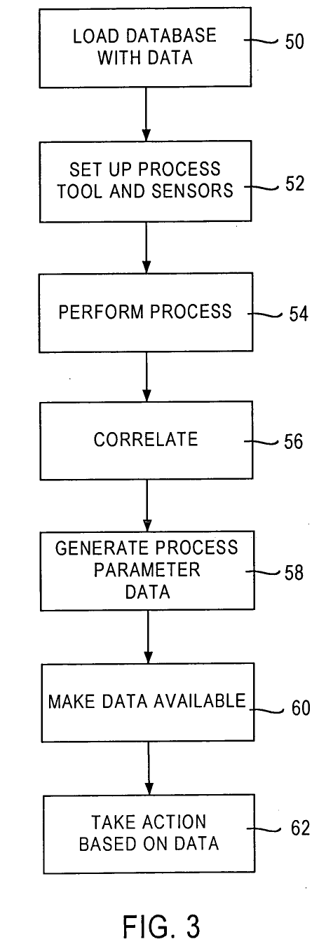

An exemplary basic process embodying the invention is depicted in FIG. 3. Assuming the components in FIG. 1 are all properly connected to the data transmission network 25, the database 22 is loaded with tool data and fabrication data as needed in step 50. The process tool 12 and sensors 24, 26 are set up by employing the information provided from the database 22, as shown in step 52. This information is obtained by browsing, as described earlier. This information includes configuration information and receipt information.

In step 54, the process tool 12 performs the desired process under the direction of the process tool controller 16. During step 54, the sensors 24, 26 generate data related to the process being performed. This data is available to the process tool controller 16 and the browser 20 on a real time basis due to the web-based connectivity provided by the system 10.

The processor 46 is able to correlate logistical tool data with the sensed data to provide detailed analysis regarding the process.

Further, the intelligent sensors 24 are also able to correlate logistical tool data with sensed data to generate process parameter date, as shown in step 58. This data is made available by the sensors 24 at the websites formed by the individual sensors 24, in step 60. Based on the information available over the web-based system 10, action may be taken, such as by sensors 24, in response to the data. This is depicted in step 62.

By providing the information for various components on a web-based data network, a more fully automatic processing system is created, at the instrument level, the process tool level and the fab level. Greater control of the system, and improved information, is obtained by the provision of data over the web of the system 10. The use of intelligent sensors is enhanced by the ability to make even more intelligent decisions by the correlation of data, such as status and recipe, with the sensor data.

Though the present invention has been described and illustrated in detail, it is to be clearly understood that the same is by way of illustration and example only and is not to be taken by way of limitation, the scope of the present invention being limited only by the terms of the appended claims.

1. A system for controlling a process, comprising:
a process tool;
a process controller that controls the process tool;
at least one sensor that senses a process parameter; and
a data transmission network coupling the process controller and the at least one first sensor, wherein the process controller and the at least one sensor are configured as web servers to deliver data over the data transmission network.

2. The system of claim 1, further comprising a database coupled to the data transmission network and is configured as a web server.

3. The system of claim 2, wherein the process controller and the at least one first sensor include web browsers for browsing the data transmission network for available data.

4. The system of claim 3, further comprising a fab controller coupled to the data transmission network, the fab controller configured as a web server and a web browser.

5. The system of claim 4, further comprising at least one second sensor that serves a process parameter, the second sensor configured only as a web server.

6. The system of claim 5, wherein at least one first sensor includes control functions responsive to available data obtained from browsing the data transmission network.

7. The system of claim 6, wherein the process tool is a semiconductor manufacturing tool.

8. A system comprising:
a production tool;
at least one peripheral data source at the production tool; and
a network to which the production tool and the at least one peripheral data source are coupled;
wherein the production tool and the at least one peripheral data source are configured for providing bi-directional flow of data over the network.

9. The system of claim 8, wherein the production tool and the at least one peripheral data source are each configured as a web server and a web browser.

10. The system of claim 9, further comprising a processor that correlates logistical production tool data with data from the at least one peripheral data source.

11. The system of claim 10, wherein the at least one peripheral data source is a first sensor for sensing the data and includes the processor.

12. The system of claim 11, wherein the processor comprises means for decision-making based on the correlated logistical production tool data and the sensed data.

13. The system of claim 12, further comprising production tool sensors coupled to the data transmission network and configured as a web server to provide sensoric data.

14. The system of claim 13, further comprising a database coupled to the data transmission network.

15. The system of claim 14, wherein a plurality of production tools and peripheral data sources are coupled to the data transmission network, and further comprising a system controller coupled to the data transmission network, the system controller providing control of the plurality of production tools.

16. The system of claim 15, wherein the plurality of production tools are semiconductor processing tools, and the database contains semiconductor process information.

17. The system of claim 16, wherein the first sensor includes means for performing an action in response to the means for decision-making.

18. A method of controlling a manufacturing process, comprising the steps:
sensing process parameter data at a process tool using a first sensor;
obtaining logistical tool data at the first sensor; and
performing an action at the first sensor based on the process parameter data and the logistical tool data.

19. The method of claim 18, wherein the first sensor is coupled to a data transmission network, and the step of obtaining logistical tool data includes the first sensor browsing the data transmission network for the logistical tool data.

20. The method of claim 19, further comprising correlating the process parameter data and the logistical tool data.

21. The method of claim 20, wherein the first sensor includes data processing capability and the step of sensing process parameter data includes obtaining sensoric data and processing the sensoric data to generate the process parameter data.

22. The method of claim 21, further comprising publishing the process parameter data on the data transmission network.

23. The method of claim 22, wherein a database and a process tool controller are coupled to the data transmission network, and further comprising publishing information at the database and the process tool controller, at least some of the information including the logistical tool data.

24. The method of claim 23, wherein the first sensor, the database and the process tool controller are configured as websites on the data transmission network.

25. The method of claim 24, further comprising a second sensor that generates sensoric data, the second sensor being configured as a website.

26. The method of claim 25, wherein the process tool is a semiconductor manufacturing process tool.
